(19) United States
(12) Patent Application Publication
(10) Pub. No.: US 2005/0006423 A1
(43) Pub. Date: Jan. 13, 2005

(54) Trail-tape dispenser

(76) Inventors: Paul Otto Kjeldsen, Mooretown (CA); Jason Tyler LaVoy, Ridgetown (CA)

Correspondence Address: BLISS MCGLYNN, P.C., 2075 WEST BIG BEAVER ROAD, SUITE 600, TROY, MI, 48084, US

(21) Appl. No.: 10/615,060

(22) Filed: Jul. 8, 2003

(51) Int. Cl. B26F 3/02

(52) U.S. Cl. 225/47; 225/78

(57) ABSTRACT

A tape dispenser is adapted to dispense trail tape and be mounted to a belt. The tape dispenser includes a housing that defines an inner cavity having a tape spool defined therein for supporting a role of tape and a storage box defined at the top of the housing. The housing includes at least one cutting edge for cutting the tape. The housing is adapted to open and close for loading and unloading of the role of tape onto and from the tape spool, to hold a portion of the distal, cut-end of the tape to prevent the portion from rolling backward into the housing, and to leave another portion of the tape extending from the housing for later cutting of the other portion.

### BACKGROUND OF THE INVENTION

1. Field of the Invention

The present invention relates, generally, to a tape dispenser and, more particularly, to a tape dispenser that is adapted to dispense trail tape.

2. Description of the Related Art

Individuals who walk in unfamiliar wooded areas—such as hunters, fishers, hikers, foresters, surveyors, and survivalists—have typically marked their trails therewithin by using trail-marking devices that guide the individuals, or trail-makers, in retracing their paths through the wooded areas. Also, it frequently occurs that these trail-makers enter the wooded areas during daylight and retrace their paths in darkness. Accordingly, these trail-marking devices must be easily visualized and found in either daylight or darkness.

In fact, it has been found that marking a trail with a strip of hunter- or blaze-orange material, which is more easily seen than material of other colors, is particularly advantageous for trail-makers traveling in daylight. In darkness, however, the hunter- or blaze-orange material is not easily viewed, and, thus, it has been found also that luminescent and/or phosphorescent material enhances the ease with which trail-makers can find a mark in darkness. For these reasons, trail-makers typically employ trail tape or ribbon that includes at least one portion of highly reflective material that is easily viewed in daylight and at least one portion of luminescent and/or phosphorescent material that is easily viewed in darkness.

Trail-makers usually stick, tie, or tack strips of the tape or ribbon to a tree limb or the like. Carrying a roll of the tape or ribbon and removing a strip of the tape or ribbon from the roll often requires use of both of their hands. However, trail-makers prefer having their hands free for performing work. As such, trail-makers desire a device for carrying and dispensing strips of the trail tape or ribbon and that they can use to mark their trails in the bush.

It is generally known to use a tape dispenser for carrying and dispensing strips of tape. A tape dispenser generally includes a spool about which a roll of the tape is wound. The tape can be readily withdrawn from the spool to any desired length and then severed for removal and application thereof to a work-piece. However, carrying the tape dispenser and removing a strip of the tape therefrom still requires use of two hands.

A tape dispenser that can be worn upon a belt is generally known also. This facilitates removal of a strip of tape from the tape dispenser with one hand, thus leaving the other hand free for performing work.

Further, the tape can be provided with a plurality of tear lines, such as perforations, to provide individual marker sections that are coupled together, yet can be separated from each other along the perforations. In this case, the tape dispenser holds the role of tape, severs the tape from the roll, and dispenses individual marker sections to allow them to be applied to a work-piece.

In spite of the benefits of the tape dispensers of the related art, they suffer from the disadvantages that they are not exclusively designed to dispense trail tape or ribbon for hunting, fishing, hiking, forestry, surveying, survival, and the like and be mounted to a belt. The tape dispensers of the related art suffer from the disadvantage also that they do not include a conveniently located storage compartment for storing accessories therein. The tape dispensers of the related art suffer from the disadvantage also that they are not designed to function for left- and right-handed persons. The tape dispensers of the related art suffer from the disadvantage also that access thereinto for loading and unloading of a roll of tape or ribbon can be complicated, time-consuming, and frustrating. The tape dispensers of the related art suffer from the disadvantage also that the number of types of belts to be used therewith is limited. Specifically, it can be difficult to mount the belt-worn tape dispensers of the related art to many types of belts. Furthermore, many types of belts interfere with dispensing of the tape or ribbon. The tape dispensers of the related art suffer from the disadvantage also that they are not sufficiently durable to handle harsh and wet weather and do not adequately protect the roll of tape or ribbon therewithin to minimize or eliminate the possibility of dirt and other foreign objects from entering the tape dispenser and interfering with dispensing of the tape or ribbon.

Thus, there is a need in the related art for a tape dispenser that is exclusively designed to dispense trail tape or ribbon for hunting, fishing, hiking, forestry, surveying, survival, and the like. In addition, there is a need in the related art for such a device that can be quickly and easily mounted to a variety of belts. Furthermore, there is a need in the related art for such a device that includes a conveniently located storage compartment for storing accessories therein. Also, there is a need in the related art for such a device that has no sharp edges thereon and is safer than the tape dispensers of the related art by including a cutting edge such that there is no need for extraneous cutting tools to cut the tape or ribbon carried by the device. Moreover, there is a need in the related art for such a device that is designed to function for left- and right-handed persons and permits for easier access thereinto for loading and unloading of a roll of tape or ribbon than do the tape dispensers of the related art. And, there is a need in the related art for such a device that permits for one-handed use such that the other hand of the user thereof can be free. Plus, there is a need in the related art for such a device that permits for dispensing of tape or ribbon from the left- and right-hand sides of the tape dispenser. Finally, there is a need in the related art for such a device that is sufficiently durable to handle harsh and wet weather and adequately protects the roll of tape or ribbon therewithin to minimize or eliminate the possibility of dirt and other foreign objects from entering the tape dispenser and interfering with dispensing of the tape or ribbon.

### SUMMARY OF THE INVENTION

The present invention overcomes the disadvantages of the tape dispensers of the related art in a tape dispenser that is adapted to dispense trail tape and be mounted to a belt. The tape dispenser includes a housing that defines an inner cavity having a tape spool defined therein for supporting a role of tape and a storage box defined at the top of the housing. The housing includes at least one cutting edge for cutting the tape. The housing is adapted to open and close for loading and unloading of the role of tape onto and from the tape spool, to hold a portion of the distal, cut-end of the tape to prevent the portion from rolling backward into the housing, and to leave another portion of the tape extending from the housing for later cutting of the other portion.

One advantage of the tape dispenser of the present invention is that it is exclusively designed to dispense trail tape or ribbon for hunting, fishing, hiking, forestry, surveying, survival, and the like.

Another advantage of the tape dispenser of the present invention is that it can be mounted to a belt.

Another advantage of the tape dispenser of the present invention is that it includes a conveniently located storage compartment for storing accessories therein.

Another advantage of the tape dispenser of the present invention is that it has no sharp edges thereon.

Another advantage of the tape dispenser of the present invention is that it is safer than the tape dispensers of the related art by including a cutting edge such that there is no need for extraneous cutting tools to cut the tape or ribbon carried by the device.

Another advantage of the tape dispenser of the present invention is that it is designed to function for left- and right-handed persons.

Another advantage of the tape dispenser of the present invention is that it permits for easier access to the roll of tape or ribbon carried therewithin than do the tape dispensers of the related art for loading and unloading of the roll.

Another advantage of the tape dispenser of the present invention is that it permits for one-handed use such that the other hand of the user thereof can be free.

Another advantage of the tape dispenser of the present invention is that it permits for dispensing of tape or ribbon from the left- and right-hand sides of the tape dispenser.

Another advantage of the tape dispenser of the present invention is that it can be used with many more types of belts than can the tape dispensers of the related art such that the belts do not interfere with dispensing of the tape or ribbon.

Another advantage of the tape dispenser of the present invention is that it is sufficiently durable to handle harsh and wet weather and protects the roll of tape or ribbon therewithin to minimize or eliminate the possibility of dirt and other foreign objects from entering the tape dispenser and interfering with dispensing of the tape or ribbon.

Other objects, features, and advantages of the tape dispenser of the present invention will be readily appreciated as the same becomes better understood while reading the subsequent description taken in conjunction with the accompanying drawings.

### BRIEF DESCRIPTION OF THE DRAWINGS

FIG. 1 is an environmental view showing an embodiment of the tape dispenser of the present invention in operation as it may be employed on a trail-maker;

FIG. 2 is a first perspective view of the embodiment of the tape dispenser of the present invention illustrated in FIG. 1 showing each of the housing and storage box of the tape dispenser in the opened position;

FIG. 3 is a second perspective view of the embodiment of the tape dispenser of the present invention illustrated in FIG. 1 showing each of the housing and storage box of the tape dispenser in the closed position;

FIG. 4 is a third perspective view of the embodiment of the tape dispenser of the present invention illustrated in FIG. 1;

FIG. 5 is a first perspective view of an alternate embodiment of the tape dispenser of the present invention showing each of the housing and storage box of the tape dispenser in the closed position;

FIG. 6 is a second perspective view of the alternate embodiment of the tape dispenser of the present invention illustrated in FIG. 5 showing each of the housing and storage box of the tape dispenser in the closed position;

FIG. 7 is third perspective view of the alternate embodiment of the tape dispenser of the present invention illustrated in FIG. 5 showing each of the housing and storage box of the tape dispenser in the opened position; and

FIG. 8 is a fourth perspective view of the alternate embodiment of the tape dispenser of the present invention illustrated in FIG. 5 showing each of the housing and storage box of the tape dispenser in the opened position.

### DETAILED DESCRIPTION OF THE INVENTION

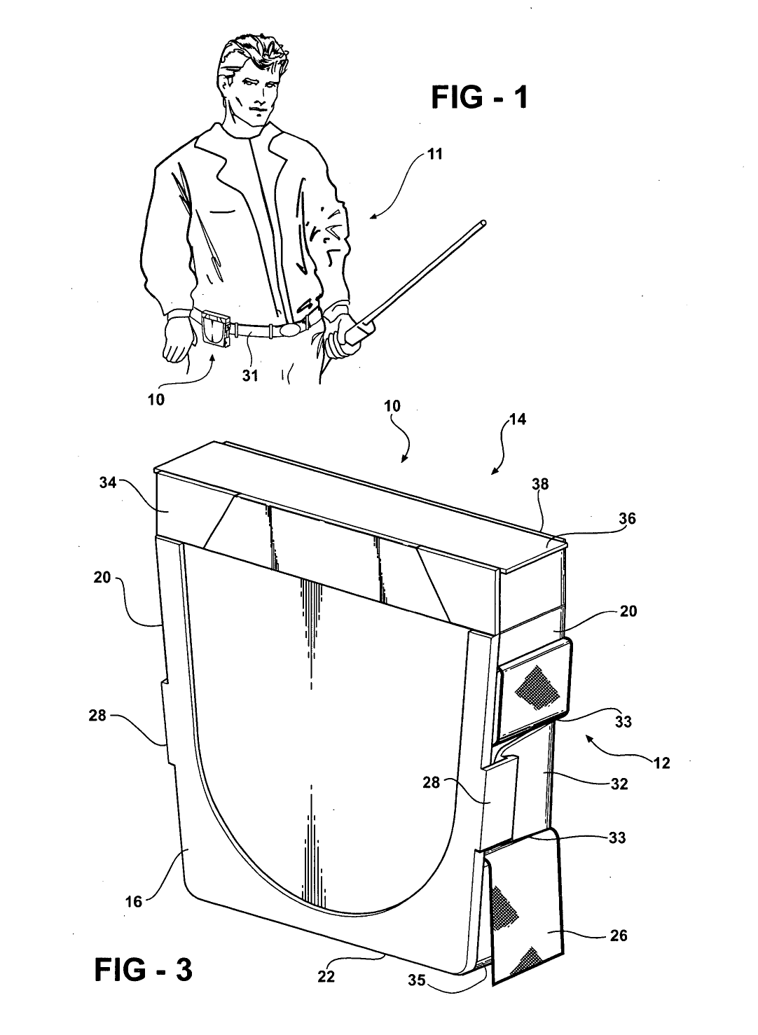

Referring now to the figures, where like numerals are used to designate like structure, an embodiment of the tape dispenser of the present invention is generally indicated at 10. The tape dispenser 10 is adapted to carry and dispense trail tape or ribbon that a trail-maker, such as a hunter, generally indicated at 11 in FIG. 1, uses to mark trails in the bush. In general, the tape dispenser 10 includes a housing, generally indicated at 12, that defines an inner cavity 13 and a storage box, generally indicated at 14, defined at the top of the housing 12.

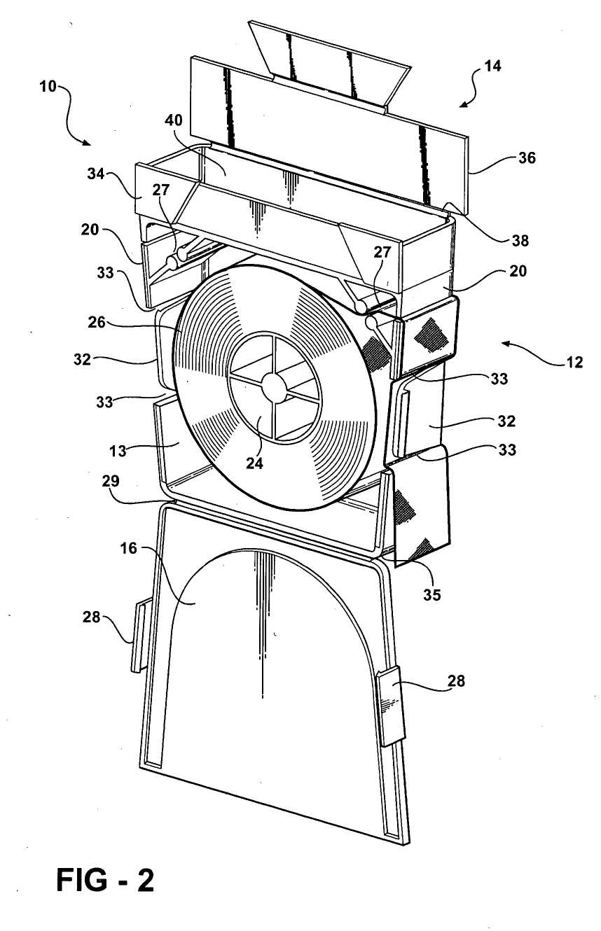

More specifically and referring now to FIGS. 2-4, preferably, the housing 12 includes a front wall 16, a rear wall 18, a pair of opposed side walls 20, and a lower wall 22. The walls 16, 18, 20, 22 cooperate with each other to define the inner cavity 13, shown in FIG. 2. Each of the walls 16, 18, 20, 22 is substantially rectangular, and the walls 16, 18, 20, 22 are structurally related such that the housing 12 is substantially box-like. However, those having ordinary skill in the art will appreciate that each of the walls 16, 18, 20, 22 can be of any suitable size and shape and be structurally related to each other to form a housing 12 of any suitable size and shape.

The inner cavity 13 has a tape spool 24 defined therein for supporting a role of tape 26. As shown in FIG. 2, preferably, the tape spool 24 is formed integrally with a substantially central portion of the interior of the rear wall 18 so as to extend into the inner cavity 13 in cantilevered fashion. However, it will be understood by those having ordinary skill in the art that the tape spool 24 can be defined in the inner cavity in any suitable manner. Furthermore, although the tape dispenser 10 is described herein and shown in FIG. 2 used in connection with tape 26, those having ordinary skill in the art will appreciate that the tape dispenser 10 can be used with any suitable material for marking trails, such as ribbon, wire, cord, and the like.

As shown in FIG. 2, preferably, the housing 12 includes a plurality of guides 27 disposed therewithin for guiding the tape 26 from the tape spool 24 to the exterior of the housing 12. More preferably, a pair of guides 27 are formed integrally with opposed, corresponding corner portions of the interior of the housing 12 proximate the storage box 14. Even more preferably, the pair of guides 27 are formed integrally with opposed, corresponding corner portions of the interior of the rear wall 18 proximate the storage box 14. The opposed guides 27 facilitate universal right-handed or left-handed use of the tape dispenser 10.

The housing 12 is adapted to open and close for loading and unloading of the role of tape 26 onto and from the tape spool 24. As shown in FIG. 2, preferably, the front wall 16 is hingedly connected at 29 to substantially the entire length of the mutual edge of the lower wall 22 so as to completely open and close for loading and unloading of the role of tape 26 onto and from the tape spool 24. The hinge 29 may be of any conventional type, including a living hinge 29 integrally molded with the front wall 16 and the lower wall 22.

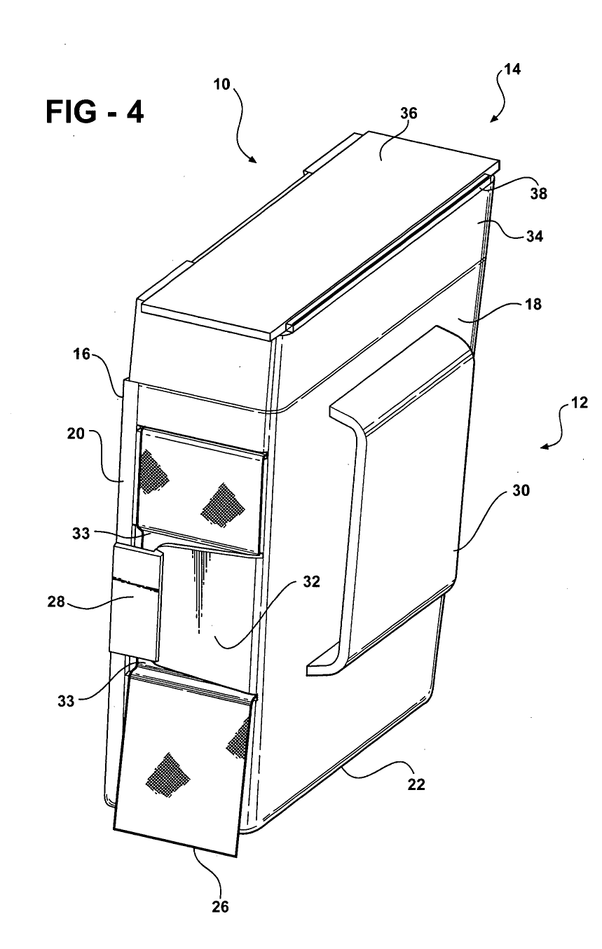

As best shown in FIGS. 3 and 4, the front wall 16 is adapted to be secured to the housing 12 in the closed position. To this end, preferably, the front wall 16 has a plurality of tabs 28 disposed thereon for securing the front wall 16 in the closed position. More preferably and as shown also in FIG. 2, the front wall 16 has a pair of opposed tabs 28 disposed on the substantially central portions of opposed, corresponding lateral edges of the front wall 16 for securing the front wall 16 to the side walls 20, as will be described in greater detail below. However, it will be understood by those having ordinary skill in the art that the front wall 16 can be designed to open and securely close for loading and unloading of the role of tape 26 onto and from the tape spool 24 in any suitable manner.

As shown in FIG. 1, the tape dispenser 10 is adapted to be mounted to a belt 31 worn by the trail-maker 11. To that end and as shown in FIG. 4, preferably, the housing 12 includes at least one belt loop 30 for looping the belt 31 through the belt loop 30. More preferably, the belt loop 30 is integrally formed with a substantially central portion of the exterior of the rear wall 18 for looping the belt 31 through the belt loop 30. The space between the rear wall 18 and the belt loop 30 is of sufficient volume to accommodate belts of many shapes and sizes. Alternatively, the belt loop 30 may include a molded tab having a downwardly extending distal end that is biased in the direction of the rear wall 18 so as to act as a clip. However, those having ordinary skill in the art will appreciate that the tape dispenser 10 can be mounted to the belt 31 in any suitable manner and the belt loop 30 can be formed with the exterior of the rear wall 18 in any suitable manner.

The housing 12 is adapted to hold a portion of the distal, cut-end of the tape 26 to prevent the portion from rolling backward into the housing 12. As shown in FIG. 2, preferably, the housing 12 is adapted to hold the portion of the tape 26 after it has moved through a guide 27 to the exterior of the housing 12. More specifically and as shown also in FIGS. 3 and 4, each of the side walls 20 has at least one tab 32 for holding the portion of the tape 26 to the side wall 20 to prevent the portion from rolling backward into the housing 12. The tabs 32 are adapted to engage the corresponding tabs 28 for securing the front wall 16 to the side walls 20. More preferably, each of the side walls 20 includes a plurality of slots 33 each of which is defined between the side wall 20 and a longitudinal end of the tab 32, for instance. In operation, the tape 26 is weaved downwardly over the side wall 20, through a slot 33, under the tab 32, through another slot 33, and over the side wall 20 for holding the portion of the tape 26. However, it will be understood by those having ordinary skill in the art that the housing 12 can hold a portion of the distal, cut-end of the tape 26 to prevent the portion from rolling backward into the housing 12 in any suitable manner.

As shown in FIGS. 2 and 3, preferably, the housing 12 includes at least one cutting edge 35 for cutting the tape 26. More preferably, the comer 35 joining each of the side walls 20 to the lower wall 22 is serrated for cutting the tape 26. However, those having ordinary skill in the art will appreciate that the cutting edge 35 can have any suitable structure and any suitable location.

The housing 12 is adapted to leave another portion of the distal, cut-end of the tape 26 extending from the tape dispenser 10 for later cutting of the other portion. As shown in FIGS. 2-4, preferably, when a portion of the tape 26 has been cut at the serrated edge 35, the tabs 32 are adapted to leave another portion of the tape 26 extending from the housing 12 for later use. However, it will be understood by those having ordinary skill in the art that the housing 12 can leave another portion of the distal, cut-end of the tape 26 extending from the housing 12 for later cutting of the other portion in any suitable manner.

As best shown in FIG. 2, preferably, the storage box 14 includes a storage compartment 34 and a hinged lid 36 that is adapted to open opposite the housing 12. More preferably, the lid 36 is hingedly connected at 38 to substantially the entire length of the edge of the storage compartment 34 proximate the rear wall 18 and adapted to completely open and close. When completely opened, the lid 36 reveals internal space 40 of the storage compartment 34, which is disposed at the top of and substantially coextensive with the housing 12. The storage compartment 34 provides a receptacle for a plurality of objects that can be used to mark trails. For example, since tree trunks or limbs can be too large around which to wrap the tape 26, the storage compartment 34 can provide tacks for tacking strips of the tape 26 to a tree trunk or the like.

The tape dispenser 10 is adapted to be worn on either side of the body. In use, the trail-maker 11 unwinds a portion of the tape 26 from the tape spool 24. The trail-maker 11 then cuts the portion along the corresponding serrated edge 35. The corresponding tab 32 leaves another portion of the tape 26 extending from the housing 12. The trail-maker 11 then sticks or ties the portion to a small limb, for example, or removes a tack from the storage compartment 34 for tacking the portion to a large tree trunk, for instance. Accordingly, the trail-maker 11 can easily find the trail markers that will guide his or her return trail.

Referring now to FIGS. 5-8, an alternate embodiment of the tape dispenser of the present invention is generally indicated at 110, where like numerals increased by 100 are used to designate like structure with respect to the tape dispenser 10 illustrated in FIGS. 1-4. Like the tape dispenser 10, the tape dispenser 110 is adapted to carry and dispense trail tape or ribbon that a trail-maker uses to mark trails in the bush. In general, the tape dispenser 110 includes a housing, generally indicated at 112, that defines an inner cavity 113 and a storage box, generally indicated at 114, defined at the top of the housing 112.

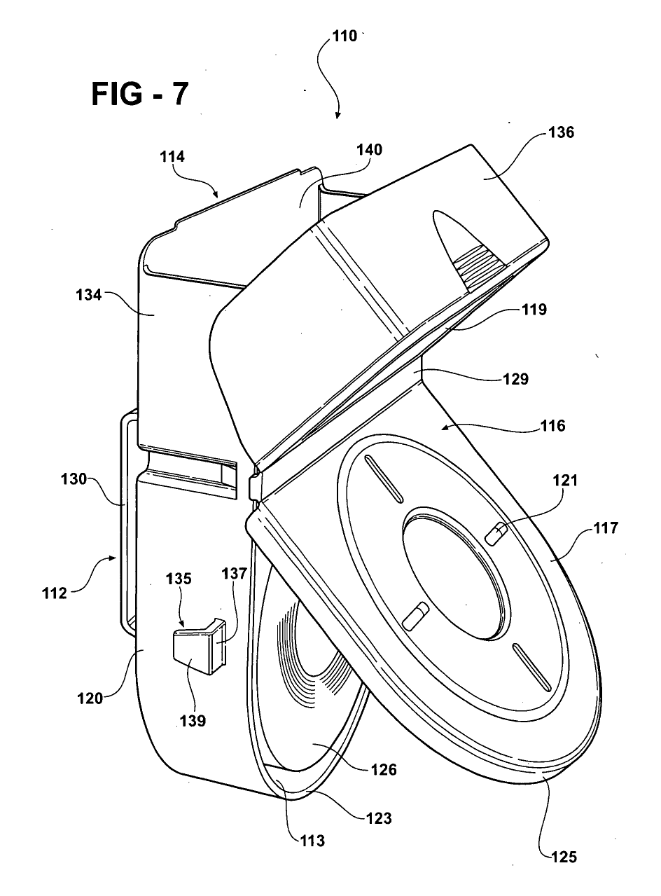

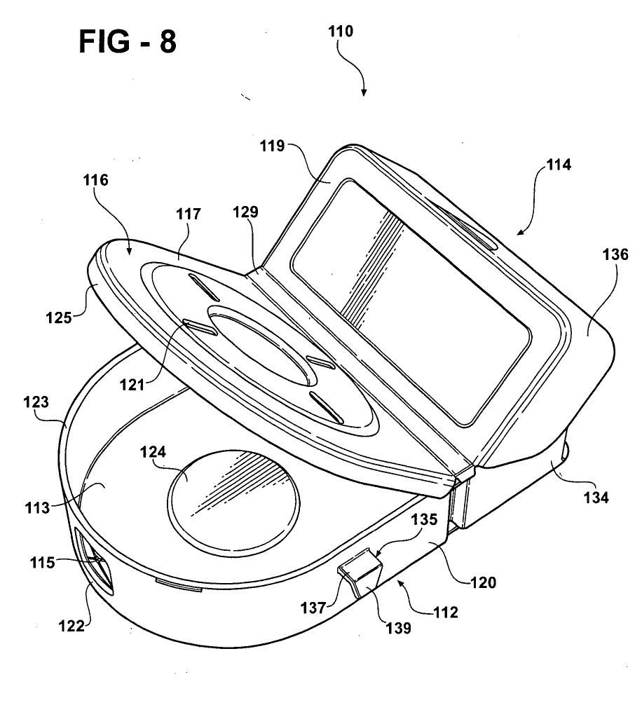

More specifically and as shown in FIGS. 5-8, preferably, the housing 112 includes a front wall, generally indicated at 116, a rear wall 118, a pair of opposed side walls 120, and a lower wall 122. The walls 116, 118, 120, 122 cooperate with each other to define the inner cavity 113, shown in FIGS. 7 and 8. Each of the walls 116, 118, 120 is substantially rectangular, and the wall 122 is substantially hemispherical.

The inner cavity 113 has a tape spool 124 defined therein for supporting a role of tape 126. As shown in FIG. 8, preferably, the tape spool 124 is formed integrally with a substantially central portion of the interior of the rear wall 118 so as to extend into the inner cavity 113 in cantilevered fashion.

The housing 112 is adapted to open and close for loading and unloading of the role of tape 126 onto and from the tape spool 124. As shown in FIGS. 7 and 8, preferably, the housing 112 includes a hinge 129 that bisects the front wall 116 to define a lower front wall 117 and an upper front wall 119. The lower front wall 117 is adapted to hingedly move about the axis defined by the hinge 129 between an open position wherein access is provided to the inner cavity 113 and a closed position wherein access to the inner cavity 113 is prevented. The upper front wall 119 is adapted to hingedly move about the axis defined by the hinge 129 between an open position wherein access is provided to the storage box 114 and a closed position wherein access to the storage box 114 is prevented. More preferably, the hinge 129 is a living hinge 129 integrally molded with the front wall 116.

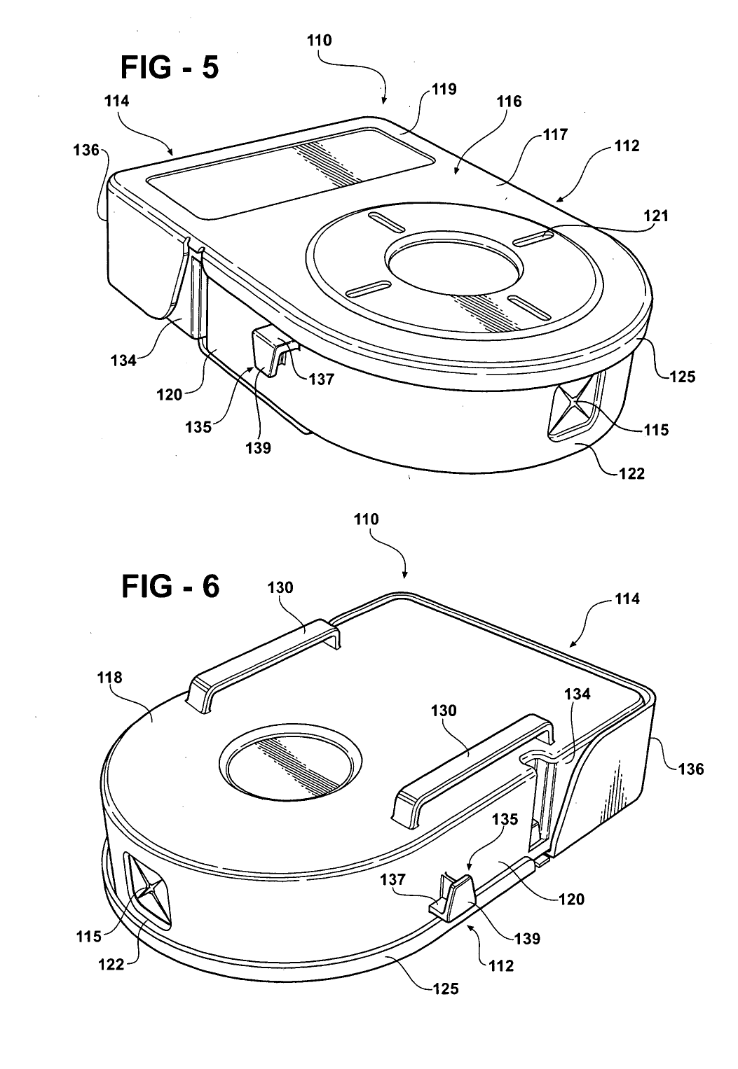

As best shown in FIGS. 5 and 6, the front wall 116 is adapted to be secured to the housing 112 in the closed position. To this end and as shown in FIGS. 7 and 8, preferably, the side walls 120 and lower wall 122 have an integral lip 123 disposed substantially thereabout. The front wall 116 has a flange 125 disposed substantially thereabout and adapted for engagement with the lip 123 for securing the front wall 116 in the closed position.

The tape dispenser 110 is adapted to be mounted to a belt 31 (FIG. 1) worn by the trail-maker 11 (FIG. 1). To that end and as shown in FIGS. 6 and 7, preferably, the housing 112 includes at least one belt loop 130 for looping the belt 31 through the belt loop 130. More preferably, a pair of opposed, spaced belt loops 130 are integrally formed with a substantially central portion of the exterior of the rear wall 118 for looping the belt 31 through the belt loops 130. The space between the rear wall 118 and each belt loop 130 is of sufficient volume to accommodate belts of many shapes and sizes.

The housing 112 is adapted to hold a portion of the distal, cut-end of the tape 126 to prevent the portion from rolling backward into the housing 112. As shown in FIGS. 5, 6, and 8, preferably, the lower wall 122 includes a flexible opening 115 for holding the portion to the lower wall 122 to prevent the portion from rolling backward into the housing 112. The flexible opening 115 is disposed in a substantially central area of the lower wall 122 to facilitate universal right-handed or left-handed use of the tape dispenser 110.

As shown in FIGS. 5-8, preferably, the housing 112 includes at least one cutting edge, generally indicated at 135, for cutting the tape 126. More preferably, each side wall 120 includes a cutting edge 135 for cutting the tape 126. Even more preferably, the cutting edge 135 includes a molded tab 135 having a proximate piece 137 extending outwardly from the side wall 120 and a distal piece 139 extending rearwardly from the end of the proximate piece 137 opposite the side wall 120.

The housing 112 is adapted to leave another portion of the distal, cut-end of the tape 126 extending from the housing 112 for later cutting of the other portion. As shown in FIGS. 5, 6, and 8, preferably, when such a portion has been cut at the cutting edge 135, the flexible opening 115 is adapted to leave another portion of the distal, cut-end of the tape 126 extending from the housing 112 for later use.

As best shown in FIG. 7, preferably, the storage box 114 includes a storage compartment 134 and a lid 136 that is adapted to open toward the housing 112. More preferably, the lid 136 is connected to substantially the entire length of the edge of the upper front wall 119 opposite the lower wall 122 and adapted to completely open and close. When completely opened, the lid 136 reveals internal space 140 of the storage compartment 134, which is disposed at the top of and substantially coextensive with the housing 112. The storage compartment 134 provides a receptacle for a plurality of objects that can be used to mark trails. For example, since tree trunks or limbs can be too large around which to wrap the tape 126, the storage compartment 134 can provide tacks for tacking strips of the tape 126 to a tree trunk or the like.

As shown in FIGS. 5, 7, and 8, preferably, the housing 112 includes a plurality of slots 121 disposed completely therethrough for allowing visual inspection of the role of tape 126 supported on the tape spool 124. More preferably, the front wall 116 includes the plurality of slots 121.

The tape dispenser 110 is adapted to be worn on either side of the body. In use, the trail-maker 11 unwinds a portion of the tape 126 from the tape spool 124. The trail-maker 11 then cuts the portion along the corresponding cutting edge 135. The flexible opening 115 leaves another portion of the tape 126 extending from the housing 112. The trail-maker 11 then sticks or ties the portion to a small limb, for example, or removes a tack from the storage compartment 134 for tacking the portion to a large tree trunk, for instance. Accordingly, the trail-maker 11 can easily find the trail markers that will guide his or her return trail.

As can easily be seen, the tape dispenser 10, 110 is designed to dispense trail tape 26, 126 for hunting, fishing, hiking, forestry, surveying, survival, and the like and be mounted to a belt 31. The tape dispenser 10, 110 includes a conveniently located storage compartment 34, 134 for storing accessories therein. The tape dispenser 10, 110 has no sharp edges thereon and is safer than the tape dispensers of the related art by including a cutting edge 35, 135 such that there is no need for extraneous cutting tools to cut the tape 26, 126 carried by the tape dispenser 10, 110. The tape dispenser 10, 110 is designed to function for left- and right-handed persons and permits for easier access to the roll of tape 26, 126 supported in the housing 12, 112 than do the tape dispensers of the related art for loading and unloading of the roll of tape 26, 126. The tape dispenser 10, 110 permits for one-handed use thereof such that the other hand can be free and for dispensing of the tape 26, 126 from the left- and right-hand sides 20, 120 of the tape dispenser 10, 110. The tape dispenser 10, 110 can be used with many more types of belts 31 than can the tape dispensers of the related art such that the belts 31 do not interfere with dispensing of the tape 26, 126. The tape dispenser 10, 110 is sufficiently durable to handle harsh and wet weather and protects the roll of tape 26, 126 therewithin to minimize or eliminate the possibility of dirt and other foreign objects from entering the tape dispenser 10, 110 and interfering with dispensing of the tape 26, 126.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A tape dispenser that is adapted to dispense trail tape and be mounted to a belt, said tape dispenser comprising:
a housing that defines an inner cavity having a tape spool defined therein for supporting a role of tape and a storage box defined at the top of said housing, said housing including at least one cutting edge for cutting the tape;
said housing adapted to open and close for loading and unloading of the role of tape onto and from said tape spool, to hold a portion of the distal, cut-end of the tape to prevent the portion from rolling backward into said housing, and to leave another portion of the tape extending from said housing for later cutting of the other portion.

2. A tape dispenser as recited in claim 1, wherein said housing includes a front wall, a rear wall, a pair of side walls, and a lower wall.

3. A tape dispenser as recited in claim 2, wherein said tape spool is formed integrally with a substantially central portion of the interior of said rear wall so as to extend into said inner cavity of said housing in cantilevered fashion.

4. A tape dispenser as recited in claim 2, wherein each of said walls is substantially rectangular.

5. A tape dispenser as recited in claim 4, wherein said housing defines a box-like enclosure.

6. A tape dispenser as recited in claim 1, wherein said housing includes a plurality of guides disposed therewithin for guiding the tape from said tape spool to the exterior of said housing.

7. A tape dispenser as recited in claim 6, wherein said plurality of guides include a pair of guides formed integrally with opposed, corresponding comer portions of the interior of said housing proximate said storage box.

8. A tape dispenser as recited in claim 2, wherein said front wall is hingedly connected to said lower wall so as to completely open and close for loading and unloading of the role of tape onto and from said tape spool.

9. A tape dispenser as recited in claim 8, wherein said hinge includes a living hinge integrally molded with said front wall and said lower wall.

10. A tape dispenser as recited in claim 2, wherein said front wall has a plurality of tabs disposed thereon for securing said front wall in the closed position.

11. A tape dispenser as recited in claim 10, wherein said plurality of tabs include a pair of opposed tabs disposed on the substantially central portions of opposed, corresponding lateral edges of said front wall for securing said front wall to said side walls.

12. A tape dispenser as recited in claim 2, wherein said housing includes at least one belt loop for looping a belt through said belt loop.

13. A tape dispenser as recited in claim 12, wherein said belt loop is integrally formed with a substantially central portion of the exterior of said rear wall of said housing.

14. A tape dispenser as recited in claim 12, wherein said belt loop includes a molded tab having a downwardly extending distal end that is biased in the direction of said rear wall so as to act as a clip.

15. A tape dispenser as recited in claim 2, wherein each of said side walls has at least one tab for holding the portion of the distal, cut-end of the tape to said side wall to prevent the portion from rolling backward into said housing.

16. A tape dispenser as recited in claim 15, wherein each of said side walls includes a plurality of slots each of which is defined between said side wall and a longitudinal end of each of said at least one tab, wherein the tape is weaved downwardly over said side wall, through one of said plurality of slots, under said at least one tab, through another of said plurality of slots, and over said side wall for holding the portion of the distal, cut-end of the tape.

17. A tape dispenser as recited in claim 2, wherein the comer joining each of said side walls to said lower wall is serrated for cutting the tape.

18. A tape dispenser as recited in claim 1, wherein said storage box includes a storage compartment and a hinged lid that is adapted to open opposite said housing.

19. A tape dispenser as recited in claim 2, wherein said lower wall is substantially hemispherical.

20. A tape dispenser as set forth in claim 2, wherein said housing includes a hinge that bisects said front wall to define a lower front wall and an upper front wall, said lower front wall adapted to hingedly move about the axis defined by said hinge between an open position wherein access is provided to said inner cavity of said housing and a closed position wherein access to said inner cavity is prevented, said upper front wall adapted to hingedly move about the axis defined by said hinge between an open position wherein access is provided to said storage box and a closed position wherein access to said storage box is prevented.

21. A tape dispenser as set forth in claim 20, wherein said hinge includes a living hinge integrally molded with said front wall.

22. A tape dispenser as recited in claim 2, wherein said pair of side walls and lower wall have an integral lip disposed substantially thereabout and said front wall has a flange disposed substantially thereabout and adapted for engagement with said lip for securing said front wall in the closed position.

23. A tape dispenser as recited in claim 12, wherein said at least one belt loop includes a pair of opposed, spaced belt loops.

24. A tape dispenser as recited in claim 23, wherein said pair of belt loops are integrally formed with a substantially central portion of the exterior of said rear wall of said housing.

25. A tape dispenser as recited in claim 2, wherein said lower wall includes a flexible opening for holding the portion of the distal, cut-end of the tape to said lower wall to prevent the portion from rolling backward into said housing.

26. A tape dispenser as recited in claim 2, wherein each of said pair of side walls includes a cutting edge for cutting the tape.

27. A tape dispenser as recited in claim 26, wherein said cutting edge includes a molded tab having a proximate piece extending outwardly from said side wall and a distal piece extending rearwardly from the end of said proximate piece opposite said side wall.

28. A tape dispenser as recited in claim 2, wherein said housing includes a plurality of slots disposed completely therethrough for allowing visual inspection of the role of tape supported on said tape spool.

29. A tape dispenser as recited in claim 28, wherein said front wall includes said plurality of slots.
